(19) United States
(12) Patent Application Publication
(10) Pub. No.: US 2009/0083368 A1
(43) Pub. Date: Mar. 26, 2009

(54) HOSTED ADS-B SYSTEM

(76) Inventors: Gregory T. Stayton, Peoria, AZ (US); Ralph C. Hedden, Phoenix, AZ (US)

Correspondence Address: SQUIRE SANDERS & DEMPSEY LLP, TWO RENAISSANCE SQUARE, 40 NORTH CENTRAL AVENUE, SUITE 2700, PHOENIX, AZ, 85004-4498, US

(21) Appl. No.: 12/235,429

(22) Filed: Sep. 22, 2008

Related U.S. Application Data
(60) Provisional application No. 60/974,254, filed on Sep. 21, 2007.

(51) Int. Cl. G06F 15/16; G06F 9/46

(52) U.S. Cl. 709/202; 709/201; 709/230; 718/104

(57) ABSTRACT

A system according to one aspect of the present invention includes two or more computer systems, the two or more computer systems each comprising a processor, a data interface, and a memory. The two or more computer systems are in communication with each other through the respective data interfaces of each of the two or more computer systems. Each memory of the two or more computer systems stores instructions that, when executed by its respective processor, cause the processor to perform at least a portion of one or more automatic dependent surveillance-broadcast (ADS-B) processes. The present invention allows a computer system that is normally dedicated to serve a particular function (such as a TAWS) to also perform ADS-B functionality using resources (such as processor cycles and memory space) that would otherwise go unutilized, ameliorating or eliminating the need for additional hardware to provide ADS-B functionality

### DESCRIPTION OF THE INVENTION

1. Field of the Invention

The present invention relates to systems and methods for hosting Automatic Dependent Surveillance Broadcast (ADS-B) functionality, and more particularly, to systems and methods for partitioning ADS-B functionality on a plurality of platforms.

2. Background of the Invention

The Automatic Dependent Surveillance-Broadcast (ADS-B) is an avionics protocol that allows an ADS-B equipped system, such as an ADS-B equipped aircraft, to “see” on a display other ADS-B equipped systems in range of the subject system. An ADS-B equipped system may comprise an aircraft, a ground-based vehicle, such as a service vehicle at an airport, or anything else that one would want to “see” using ADS-B. Air traffic control may also use ADS-B to “see” ADS-B equipped systems.

Under the ADS-B protocol, an ADS-B equipped system periodically broadcasts its own state vector and other information without knowing which, if any, other ADS-B equipped systems might be receiving it, and without expectation of an acknowledgement or reply. ADS-B is “automatic” in the sense that no pilot or controller action is required for the information to be issued. ADS-B is “dependent surveillance” in the sense that the surveillance-type information so obtained depends on the suitable navigation and broadcast capability of the ADS-B equipped system making the transmission. ADS-B systems automatically and repeatedly broadcast the aircraft's position, velocity, flight identification, and other parameters. ADS-B systems are generally equipped with Global Positioning Systems (GPS) to allow the aircraft to determine and broadcast its position accurately.

In operation, an aircraft or other ADS-B equipped system determines position information about itself, typically employing the global positioning system (GPS). The position information is employed to create a digital code, which may be combined with other information such as aircraft type, aircraft speed, aircraft flight number and whether the aircraft is turning, climbing or descending. The digital code, which may contain all of this information or in some cases more or less information, is updated several times a second and broadcast from the ADS-B-equipped system on a discrete frequency, called a data link. To transmit and receive ADS-B, an ADS-B equipped system may employ a Mode-S Extended Squitter (1090 ES) transponder, a Universal Access Transceiver (UAT), both a Mode-S Extended Squitter (1090 ES) transponder and a Universal Access Transceiver (UAT), or any equivalents thereof. ADS-B equipped systems, such as an aircraft or a ground station, within about 150 miles of an ADS-B transmission source may receive the ADS-B and display the received information. For example, a pilot in an aircraft cockpit can see traffic on a Cockpit Display of Traffic Information (CDTI). Additionally, air traffic controllers on the ground can see ADS-B traffic on their traffic display screen, as well as other radar targets.

Today, while some aircraft are equipped with ADS-B systems, there are many aircraft that do not have this capability. The United States Federal Aviation Administration (FAA) has mandated that ADS-B systems must be included on all aircraft by 2020 to allow the position and movement of aircraft to be tracked in order to help avoid collisions at an airport or other location. However, adding ADS-B functionality (and conventional hardware to support it) to an existing aircraft can be difficult, time-consuming, and expensive. Moreover, due to space and weight constraints in existing aircraft, it may not even be possible to add a TCAS, FMS, or ISS LRU to provide the desired ADS-B functionality. The present invention addresses these and other issues.

### SUMMARY OF THE INVENTION

A system according to one aspect of the present invention includes two or more computer systems, the two or more computer systems each comprising a processor, a data interface, and a memory. The two or more computer systems are in communication with each other through the respective data interfaces of each of the two or more computer systems. Each memory of the two or more computer systems stores instructions that, when executed by its respective processor, cause the processor to perform at least a portion of one or more automatic dependent surveillance-broadcast (ADS-B) processes. The present invention allows a computer system that is normally dedicated to serve a particular function (such as a TAWS) to also perform ADS-B functionality using resources (such as processor cycles and memory space) that would otherwise go unutilized, ameliorating or eliminating the need for additional hardware to provide ADS-B functionality.

Both the foregoing summary and the following detailed description are exemplary and explanatory only and are not restrictive of the invention.

### BRIEF DESCRIPTION OF THE DRAWINGS

A more complete understanding of the present invention may be derived by referring to the detailed description and claims when considered in connection with the following illustrative figures.

FIG. 1 is a block diagram depicting an exemplary system according to various aspects of the present invention.

### DETAILED DESCRIPTION OF EXEMPLARY EMBODIMENTS

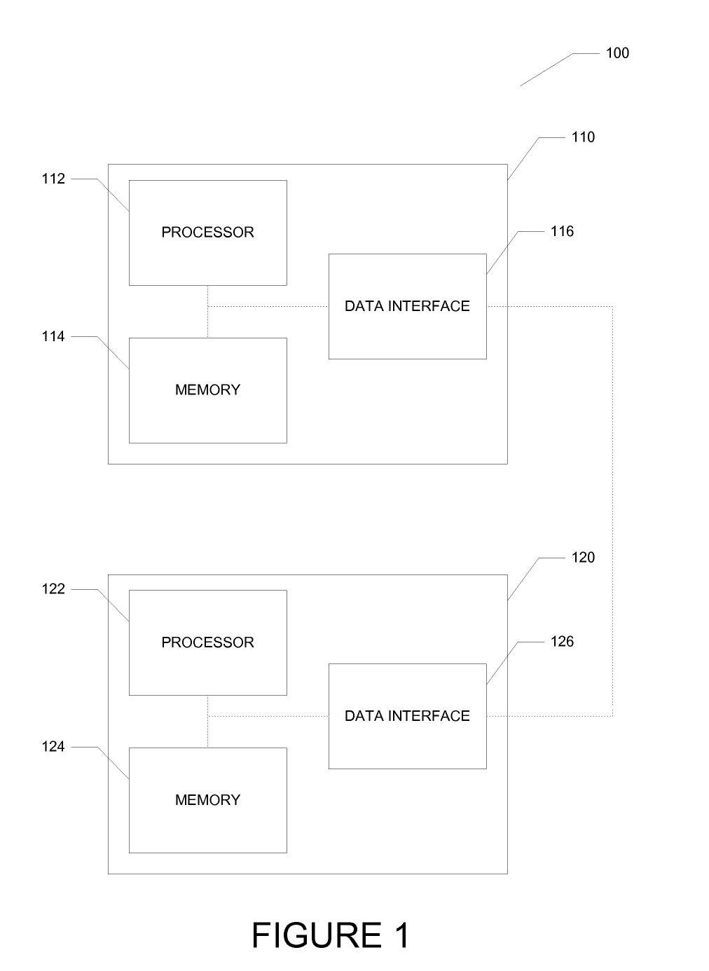

An exemplary system according to the present invention is depicted in FIG. 1. This system includes a computer system 110, which comprises a processor 112, memory 114, and a data interface 116. The system further includes a computer system 120, which comprises a processor 122, memory 124, and data interface 126. The computer systems (110, 120) are in communication with each other through their respective data interfaces (116, 126). Other embodiments of the present invention may include any number of computer systems. Computer systems operating in conjunction with the present invention may be any suitable device, such as: an electronic flight bag (EFB), a display, a terrain awareness warning system (TAWS), a weather radar, a transponder, a radio, an integrated modular avionics card, an integrated modular avionics module, a line replaceable unit (LRU) (such as a traffic collision and avoidance (TCAS) LRU and/or an integrated surveillance system (ISS) LRU), and combinations thereof.

Computer systems operating in conjunction with the present invention may provide ADS-B functionality in any suitable manner, such as through the processors 112, 122 executing software instructions stored in memories 114, 124, respectively. ADS-B functionality may also be implemented through various hardware components storing machine-readable instructions, such as application-specific integrated circuits (ASICs), field-programmable gate arrays (FPGAs) and/or complex programmable logic devices (CPLDs). Systems of the present invention may operate in conjunction with any desired combination of software and/or hardware components.

In the exemplary embodiment depicted in FIG. 1, the processors 112, 122 retrieve and execute instructions stored, respectively, in memories 114 and 124 to control the operation of the computer systems and to perform at least a portion of one or more ADS-B processes. Any number and type of processor(s) such as an integrated circuit microprocessor, microcontroller, and/or digital signal processor (DSP), can be used in conjunction with the present invention. The present invention allows a computer system that is normally dedicated to serve a particular function (such as a TAWS) to also perform ADS-B functionality using resources (such as processor cycles and memory space) that would otherwise go unutilized.

Each computer system 110, 120 depicted in FIG. 1 includes a memory 114, 124. The memories 114, 224 store instructions and data. A memory operating in conjunction with the present invention may include any combination of different memory storage devices, such as hard drives, random access memory (RAM), read only memory (ROM), FLASH memory, or any other type of volatile and/or nonvolatile memory. Computer systems 112, 114 may also comprise external storage media such as a FLASH drive or a portable hard drive. Any number of memory storage devices of any size and configuration may also be used in conjunction with the present invention.

In the exemplary embodiment depicted in FIG. 1, each memory 114, 124 stores instructions to cause its respective processor (112, 122) to perform at least a portion of one or more ADS-B processes. Any ADS-B-related function (or portion thereof) can be performed by a computer system operating in conjunction with the present invention, such as processes relating to: Surface Area Movement Management (SAMM), Cockpit Display of Traffic Information (CDTI)-Assisted Visual Separation (CAVS), Enhanced Traffic Situational Awareness during Flight Operations, In-Trail Procedure (ITP) in Non-Radar Oceanic Airspace, Merging and Spacing (M&S), Parallel Approach, Airborne Conflict Management, and combinations thereof.

Memories 114 and 124 can store instructions to perform some or all of an ADS-B-related process. The memories 114, 124 can store the same instructions, data, functions, and/or software to provide redundancy in the event that one of the computer systems 110, 120 becomes inoperable or does not have the resources to perform the entire process by itself. Similarly, multiple computer systems operating in accordance with the present invention can store instructions to perform the same functions to allow resources (such as memory space and processor cycles) to be dynamically allocated based on (for example) the resources available at the point in time when the ADS-B process requires execution.

For example, the processor bandwidth and memory space in a TAWS may be sufficient to entirely perform a SAMM process when the TAWS is not detecting/reporting a terrain conflict. When the TAWS is detecting/reporting a terrain conflict, however, it may be necessary to transfer some or all of the responsibility for performing the SAMM process to one or more other computer systems that have spare processing and memory bandwidth. For example, the TAWS could perform one subset of functions related to the SAMM process, while another computer system (or plurality of computer systems) could perform the remaining subset of functions. In this manner, ADS-B functionality can be dynamically partitioned and allocated based on the spare resources (e.g., processor cycles and memory space) available on existing systems in an aircraft, ameliorating or eliminating the need for additional hardware to provide ADS-B functionality.

Separate computer systems operating in conjunction with the present invention may also store different instructions to execute different ADS-B processes. This allows multiple ADS-B processes to be performed simultaneously across multiple computing platforms, and can enable ADS-B functionality to be performed more quickly than if a single system were responsible for providing all ADS-B functionality by itself.

In the exemplary system shown in FIG. 1, data is transmitted and received through the data interfaces 116, 126. The data interfaces 116, 126 may include any suitable hardware or software components and may communicate through any desired connection. For example, the data interfaces 116, 126 may communicate through a wired connection. In the context of this application, a “wired connection” refers generally to any physical connection that allows communication between two devices, such as a serial peripheral interface bus (SPI) connection; universal serial bus (USB) connection; a serial connection, Ethernet connection, optical fiber connection, and/or Firewire connection. Multiple computer systems can be connected through a common wired connection, such as a PCI bus, ISA bus, PCI-E bus, SPI, USB, or other common connection. Computer systems 110, 120 can communicate through individual wired connections, or through any combination of common wired connections and individual wired connections.

The data interfaces 116, 126 can also communicate wirelessly. Any suitable method of wireless communication can be used, such as a Bluetooth connection, infrared radiation, IEEE 802.15 protocol, IEEE 802.11 protocol, IEEE 802.16 protocol, and/or ultra-wideband (UWB) protocol. Data can be transmitted and received by computer systems operating in conjunction with the present invention using any number and combination of wired or wireless connections, as well as any other type of connection. Additionally, computer systems operating in conjunction with the present invention may communicate data using any suitable format and communications protocol, such as Aeronautical Radio, Incorporporated (ARINC) standard 429. While it is not necessary that all computer systems operating in conjunction with the present invention use the same communications protocol, the use of a common communications protocol can provide more efficient communication and reduce or eliminate the need for software or hardware to translate from one communication protocol to another.

Any form of data can be transmitted and received through the data interfaces 116, 126. In addition to data related to ADS-B functionality, software updates can be delivered to the computer systems 110, 120 through the data interface and stored in the respective memories 114, 124 to change, replace, or supplement the existing functionality of the computer system.

Data transmitted and received by computer systems operating in conjunction with the present invention can be relayed through any number of relay devices, such as routers, hubs, bridges, switches, modems, and other computer systems. Among other things, allowing a computer system to relay data between two other computer systems allows multiple computer systems to communicate with each other without requiring a direct connection between every computer system, and without requiring the addition of new hardware.

Computer systems operating in accordance with the present invention can transmit data to, or receive data from, any person, system, or device. For example, some or all of the computer systems performing at least a portion of one or more ADS-B processes may receive information from a global positioning system (GPS), as well as data received from another aircraft through a radio receiver. Similarly, computer systems of the present invention may provide data to a transmitter to transmit ADS-B data to other aircraft or ground stations. Computer systems of the present invention may also interface with audio systems, displays, or other equipment to provide audio and visual messages and alerts to a flight crew.

The particular implementations shown and described above are illustrative of the invention and its best mode and are not intended to otherwise limit the scope of the present invention in any way. Indeed, for the sake of brevity, conventional data storage, data transmission, and other functional aspects of the systems may not be described in detail. Methods illustrated in the various figures may include more, fewer, or other steps. Additionally, steps may be performed in any suitable order without departing from the scope of the invention. Furthermore, the connecting lines shown in the various figures are intended to represent exemplary functional relationships and/or physical couplings between the various elements. Many alternative or additional functional relationships or physical connections may be present in a practical system.

Changes and modifications may be made to the disclosed embodiments without departing from the scope of the present invention. These and other changes or modifications are intended to be included within the scope of the present invention, as expressed in the following claims.

What is claimed is:

1. A system comprising:
two or more computer systems, the two or more computer systems each comprising:
a processor;
a data interface; and
a memory;
wherein the two or more computer systems are in communication with each other through the respective data interfaces of each of the two or more computer systems;
wherein each memory of the two or more computer systems stores instructions that, when executed by its respective processor, cause the processor to perform at least a portion of one or more automatic dependent surveillance-broadcast (ADS-B) processes.

2. The system of claim 1, wherein the two or more computer systems are selected from the group consisting of:
an electronic flight bag (EFB);
a display;
a terrain awareness warning system (TAWS);
a weather radar;
a transponder;
a radio;
an integrated modular avionics card;
an integrated modular avionics module;
a line replaceable unit (LRU); and
combinations thereof.
data relay transceiver includes a wireless transmitter for transmitting the data wirelessly to the intermediary device.

3. The system of claim 2, wherein at least one of the two or more computer systems is an LRU selected from the group consisting of:
a traffic collision avoidance system (TCAS) LRU;
an integrated surveillance system (ISS) LRU; and
combinations thereof.

4. The system of claim 1, wherein the one or more ADS-B processes are selected from the group consisting of:
an process for Surface Area Movement Management (SAMM);
an process for Cockpit Display of Traffic Information (CDTI) - Assisted Visual Separation (CAVS);
an process for Enhanced Traffic Situational Awareness during Flight Operations;
an process for In-Trail Procedure (ITP) in Non-Radar Oceanic Airspace;
an process for Merging and Spacing (M&S);
an process for Parallel Approach;
an process for Airborne Conflict Management; and
combinations thereof.

5. The system of claim 1, wherein at least two of the two or more computer systems are configured to perform the same portion of an ADS-B process.

6. The system of claim 1, wherein each of the data interfaces of the two or more computer systems utilize a common communications protocol.

7. The system of claim 1, wherein each of the two or more computer systems are configured to:
receive a software update through their respective data interfaces; and
store the software update in their respective memories.

8. The system of claim 1, comprising at least three computer systems, wherein at least one computer system is configured to relay data between the other two computer systems.

9. The system of claim 1, wherein the two or more computer systems are configured to dynamically allocate processor resources to perform the one or more ADS-B processes.

10. The system of claim 1, wherein the two or more computer systems are configured to dynamically allocate memory resources to perform the one or more ADS-B processes.

11. The system of claim 1, wherein at least two of the data interfaces of the two or more computer systems communicate through a wired connection.

12. The system of claim 1, wherein at least two of the data interfaces of the two or more computer systems communicate through a wireless connection.
